(19) United States
(12) Patent Application Publication
(10) Pub. No.: US 2012/0110663 A1
(43) Pub. Date: May 3, 2012

(54) APPARATUS AND METHOD FOR INPUTTING USER PASSWORD

(75) Inventors: Soo Hyung Kim, Daejeon (KR); Taekyoung Kwon, Seoul (KR); Seung-Hyun Kim, Daejeon (KR); Dae Seon Choi, Daejeon (KR); Jong-Hyouk Noh, Daejeon (KR); Sangrae Cho, Daejeon (KR); Young Seob Cho, Daejeon (KR); Seung Hun Jin, Daejeon (KR)

(73) Assignee: Electronics and Telecommunications Research Institute, Daejeon (KR)

(21) Appl. No.: 13/286,772

(22) Filed: Nov. 1, 2011

(30) Foreign Application Priority Data
Nov. 3, 2010 (KR) 10-2010-0108749

(51) Int. Cl. G06F 21/00

(52) U.S. Cl. 726/19

(57) ABSTRACT

An apparatus for inputting a user password, includes an interface receiving a command. Further, the apparatus for inputting the user password includes a control unit setting a target based on the command from the interface, receiving and storing a password character, and determining that authentication is successes only when the set target and the password character are positioned at a same coordinate on a skin image. Furthermore, the apparatus for inputting the user password includes a display unit connected to the interface to display the skin image of the interface that is transmitted from the control unit.

### CROSS-REFERENCE TO RELATED APPLICATION(S)

The present invention claims priority of Korean Patent Application No. 10-2010-0108749, filed on Nov. 3, 2010, which is incorporated herein by reference.

### FIELD OF THE INVENTION

The present invention relates to an apparatus for and a method of inputting a user password, and more particularly, to an apparatus and a method for inputting a user password in safe and conveniently against shoulder-surfing attack and malicious logger in a public digital device when a user inputs his/her user password into the public digital device.

### BACKGROUND OF THE INVENTION

In recent years, as automatic teller machines (ATM) are popularized and mobile banking using a mobile phone is routinized, individuals frequently input own passwords in public places.

Particularly, recent rapid distribution of smartphones makes personal user input own password without restriction of time and place very frequently. In this case when a user inputs his/her password in public place, shoulder-surfing attack, that is, hacking of a user password may be easily occurred by stealing a glance of a screen of an input device or of an input pattern of the password.

Specifically, in a mobile phone and ATM in which four digit numbers are used as a password, the above-mentioned attack may be easily made without any additional device such as a voyeur camera or a hidden camera. Many techniques fighting against the shoulder-surfing attack have been suggested but these techniques are suitable for a device such as a personal computer equipped with a large scale screen and a convenient input/output devices such as a mouse. There is not something technique suitable for a device with a small screen and a poor I/O device such as a mobile phone and ATM.

On the other hand, recent hacking smartphone becomes issue and loading of a program fighting against a logger who steals keystrokes and a screen image in mobile banking is common. However, this logger prevention program is effective only to internal danger of smart phone but flabby against shoulder-surfing attack. The majority of the logger prevention programs emulates a user interface provided by a personal computer as it is so that a user feels inconvenience to use.

### SUMMARY OF THE INVENTION

In view of the above, the present invention provides an apparatus and a method for inputting a personal user password in safe and conveniently through a digital device such as a mobile phone, ATM, a tablet PC, and the like at public place.

Moreover, the present invention also provides a user password inputting apparatus for and a method of inputting the user password against shoulder-surfing attack and a malicious logger inside a digital device when a user inputs his/her password in the digital device used at a public place, and being implemented to be conveniently applied to a mobile digital device.

The present invention further provides a user password inputting apparatus and a method for resisting shoulder-surfing attack and a malicious logger inside a digital device through authentication of matching characters of the user password to a target set by the user on coordinates in the digital device used at a public place.

In accordance with a first aspect of the present invention, there is provided an apparatus for inputting a user password. The apparatus for inputting the user password includes an interface receiving a command; a control unit setting a target based on the command from the interface, receiving and storing a password character, and determining that authentication is successes only when the set target and the password character are positioned at a same coordinate on a skin image; and a display unit connected to the interface to display the skin image of the interface that is transmitted from the control unit.

In accordance with a second aspect of the present invention, there is provided a method for inputting a user password. The method for inputting the user password includes receiving a command from an interface; registering a target and a password character based on the command by a control unit; displaying a skin image of the interface on which a plurality of targets and a plurality of password characters are arranged at random when authentication is performed; and checking, when a command of requesting for authentication is received from the interface, extracted information and determining successful authentication only when the registered target and the registered password character are positioned at the same coordinate as that of the skin image.

In accordance with an embodiment of the present invention, the apparatus and method for inputting a user password have the following effects.

In accordance with the apparatus and method for inputting the user password of the present invention, the user password may be inputted in safe and conveniently in various digital devices such as a mobile phone, ATM, a tablet PC, and the like, so that security of protecting the user password from shoulder-surfing attack and a malicious logger inside the digital device can be guaranteed and that a user can conveniently input his/her password with only few clicks of buttons or screen touches on a mobile phone, and the like.

Further, the apparatus and method for inputting the user password of the present invention do not need any additional device attached to a digital device when the apparatus and the method are implemented in the digital device, and may be implemented only by modifying software of a user interface module.

### BRIEF DESCRIPTION OF THE DRAWINGS

The objects and features of the present invention will become apparent from the following description of embodiments given in conjunction with the accompanying drawings, in which:

FIG. 1 is a block diagram illustrating a user terminal in accordance with an embodiment of the present invention;

FIG. 2 is a view illustrating a password input interface of the user terminal in accordance with the embodiment of the present invention;

FIG. 3 is a view illustrating arrangement of a set of characters used as password on a user terminal in accordance with the embodiment of the present invention;

FIG. 4 is a view illustrating arrangement of a set of target candidates and a set of characters in accordance with embodiment of the present invention;

FIG. 5 is a view illustrating an input of a password character positioned on targets in accordance with the embodiment of the present invention;

FIG. 6 is a flow chart illustrating registering of a user password in a user terminal in accordance with the embodiment of the present invention; and

FIG. 7 is a flow chart illustrating process of inputting and authenticating a user password in a user terminal in accordance with the embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

In order to achieve two objects, that is, safety and user convenience, a range of a user recognition, and range and times of finger movement may be considered.

Hereinafter, embodiments of the present invention will be described in detail with reference to the accompanying drawings which form a part hereof.

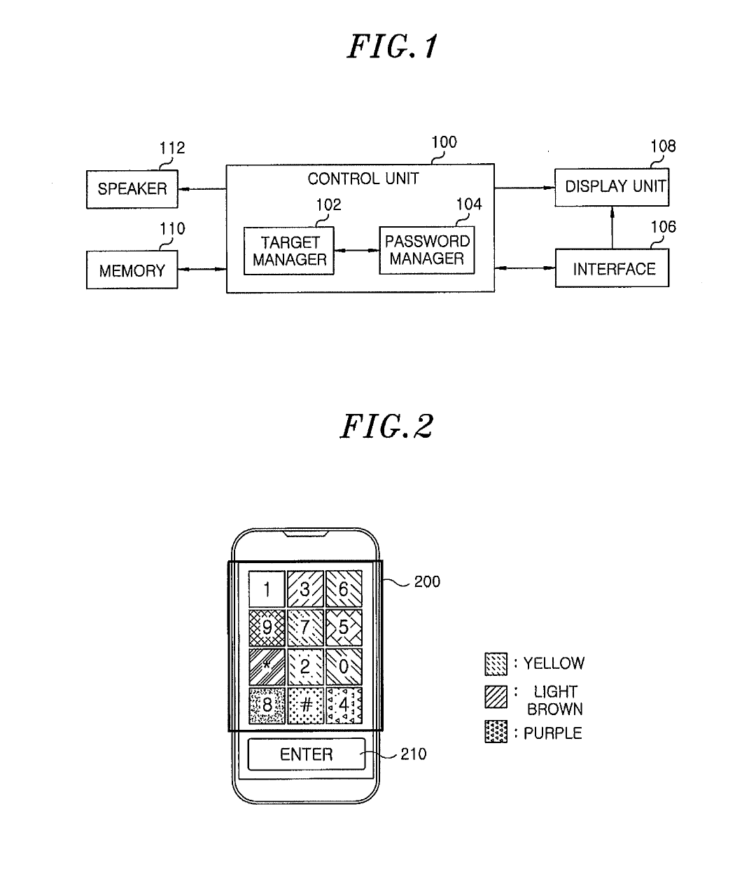

FIG. 1 is a block diagram illustrating a user terminal in accordance with an embodiment of the present invention.

Referring to FIG. 1, a user terminal may be a touch screen type computer device such as a tablet computer, ATM, a smartphone, and the like, and includes a control unit 100, a target manager 102, a password manager 104, an interface 106, a display unit 108, a memory 110, and a speaker 112.

The control unit 100 controls the above respective elements and performs user authentication based on a target and password characters. The control unit 100 includes the target manager 102 and the password manager 104. The control unit 100 performs the authentication of a user by which the target manager 102 sets at least one target based on a command from a user and which the password manager 104 sets and registers at least one password character.

The control unit 100 arranges the target and the password character on an interface screen at random, that is, arrange respective targets and password characters on a skin image at random to form a password input interface. In the password input interface, the targets and the password characters may move based on the user command and finally the authentication is determined by comparing the status that the target and the password character are positioned with preset information.

In this case, the target is set in advance in order for a user to input one password character through the password input interface and means specific information that the user needs to recognize in advance. This specific information may be assigned by a specific color, a pattern, an icon, and a part of an image. The set of target candidates may be a set of information that is easily distinguished by user's eyes and identical to the number of characters to be displayed on the skin image.

The password characters displayed on the password input interface are determined by a series of character sets such as personal identification number (PIN) of 0 (zero) to 9, extended PIN of 0 (zero) to 9, #, and *, and more extended PIN of 0 (zero) to 9, alphabet, Hangeul, and special characters, and may be changed according to a set of password characters which a user can select for the password.

The selectable character set may be determined during designing of authentication performed by the control unit 100.

The authentication in the control unit 100 may be designed in various conditions, for example, such that only alphabet excluding numbers are input into a first digit of a password and that only numbers are input into a second digit of the password.

The interface 106 includes a keypad or a touch screen and may receive a command from a user. The interface 106 may deliver the password input interface transmitted from the control unit 100 to be displayed on the display unit 108.

In the password input interface, the skin images of the targets and the password characters are arranged at random.

The display unit 108 outputs a control signal transmitted from the control unit 100 to be displayed for a user in association with the interface 106 and may display the password input interface, an authentication success message, and an authentication failure message.

The memory 110 stores target setting information and password character setting information that are transmitted from the target manager 102 and the password manager 104 of the control unit 100 in a preset region. The memory 110, when the target manager 102 and the password manage 104 request for the setting information, transmits corresponding information.

The speaker 112 output sound or voice that is transmitted from the control unit 100 and may output voice or sound corresponding to success or failure of authentication when the authentication is performed.

FIG. 2 is a view illustrating a password input interface of the user terminal in accordance with the embodiment of the present invention. The password input interface of FIG. 2 is optimized to a screen of a mobile phone and may be slightly modified according to a digital device to which the password input interface is applied.

For example, since a tablet computer and ATM have larger display device than a mobile phone, the number and arrangement of characters displayed on the display device may be also changed.

Referring to FIG. 2, a character (for example, 0 (zero) to 9, *, #, and the like) displayed on the password input interface 200 indicates one of password character string of a user and different colors assigned to the respective characters indicate target candidates. For example, displayed colors such as yellow, red, blue, and the like may be a target. The target may be set in step of registering a password by a user and may be always delivered to the user directly before the user inputs the password such that the user may recognize the password. A method of delivering the target to the user directly before inputting the password may be carried out by the speaker 112, the display unit 108, or a user interface connected to the interface 106.

For example, a specific pattern that is transformed visually or acoustically using an image completely automated public test to tell computers and humans apart (CAPTCHA) and an audio CAPTCHA is provided to a user so that the control unit 100, when the user inputs a value corresponding to the pattern with a user terminal, may determine the input and provide selected target information through the display unit 108 or the speaker 112 only when matched information is inputted.

The user may perform the input by putting one character of the password character string on the password input interface 200 to the target and by pressing an enter button 210. For example, in a case where yellow color is assigned to a target and a password is set as the number of 2 (two), the authentication success message may be confirmed when the input button 210 is pressed.

In this case, the input button 210 is the simulation of a touch screen and may be replaced with a keypad button on a hardware keyboard (QWERTY keyboard, a button of a mobile phone, and the like.). Putting of characters on a target will be described in the following description of FIG. 4 in detail.

Hereinafter, a method of arranging characters, arranging a target, and putting and inputting a character on the target will be described in detail with reference to FIGS. 2 to 4.

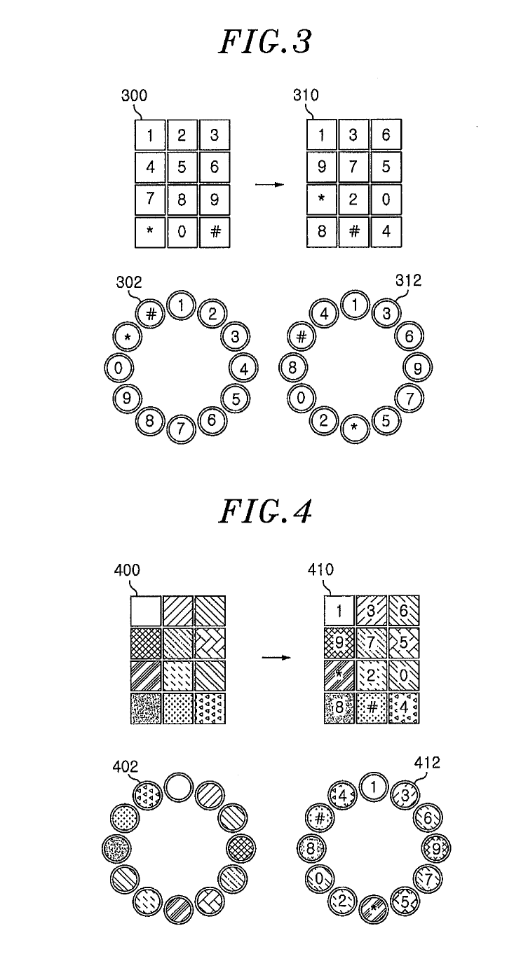

FIG. 3 is a view illustrating arrangement of a set of characters used as password on a user terminal in accordance with the embodiment of the present invention.

Referring to FIG. 3, the arrangement of the character set in the password input interface assigned with the reference numeral 300 complies with the arrangement of characters on a hardware keyboard of a mobile phone and simulates respective characters of a character set of 0 (zero) to 9, #, and * by arranging the respective characters on the same skin image as the hardware keyboard.

The skin image has a pair of the number on which the respective characters of the character set is placed and a screen coordinate and may be implemented in the circular form 302 such as a telephone dial and a keyboard type of a mobile phone such as an interface indicated by a reference numeral 300. The number of characters displayed on the skin image needs to be equal to or greater than a size of the character set used as a password. A reference numeral 310 indicates an arrangement of characters randomly shuffled and a reference numeral 312 indicates the arrangement of the shuffled characters implemented in the circular form 302 such as a telephone dial.

That is, although the character set is not changed, the respective characters are provided with respective unique number as a result of the shuffle, wherein the respective number indicate respective skin images. The respective characters provided with numbers may be displayed on the screen coordinates matched with the respective numbers of the skin images.

FIG. 4 is a view illustrating arrangement of a set of target candidates and a set of characters in accordance with an embodiment of the present invention.

Referring to FIG. 4, an interface assigned by a reference numeral 400 indicates the target candidates randomly shuffled and provided with unique numbers by the target manager 102 of the control unit 100 and a reference numeral 402 indicates circular target candidates.

Interfaces assigned with reference numerals 410 and 412 indicates the interfaces 400 and 402 provided with respective numbers of the character set by the password manager 104. That is, the interface 410 expresses both of the interface 310 shown in FIG. 3 and the interface 400 shown in FIG. 4, and by doing so the password input interface may be completed. Thus, a user may move a character to be input to a target that the user recognizes so that the inputting of a password may be performed.

In other words, the skin image of the password input interface may have characters, position coordinates on which the targets are displayed, and unique numbers with respect to corresponding position coordinates. Therefore, the control unit 100 randomly shuffles all of the target candidates and the characters to be mapped with the unique numbers of the skin images one by one in order in association with the target manager 102 and the password manager 104 to arrange the target candidates and the characters on the skin images of the password input interface at random and may be provided with selected numbers to the target candidates and the characters. The control unit 100 may arrange the targets and the characters at coordinate positions matched to the numbers of the skin images.

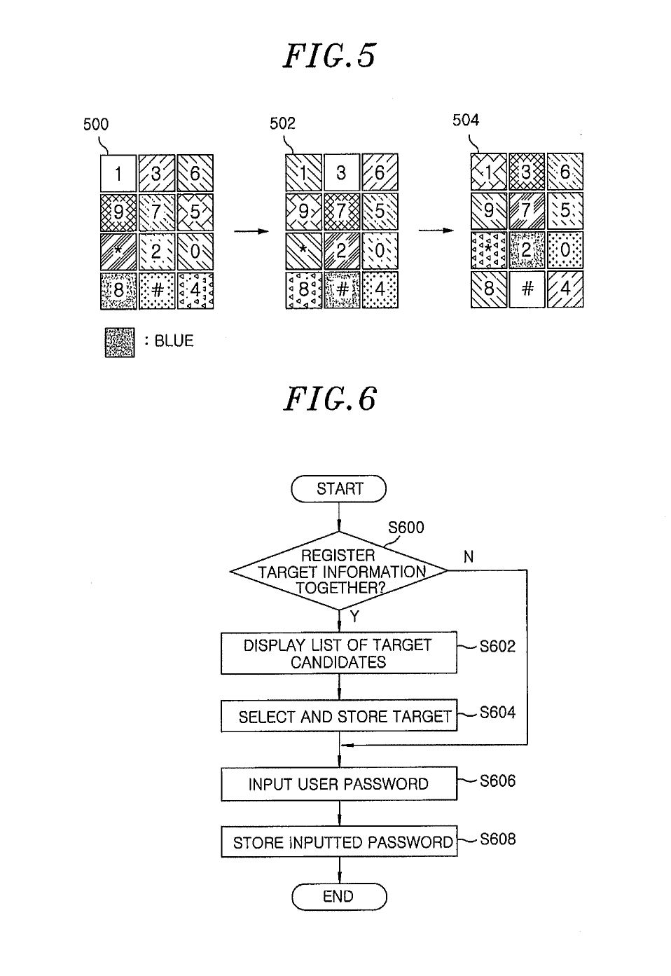

FIG. 5 is a view illustrating an input of a password character positioned on targets in accordance with the embodiment of the present invention.

Referring to FIG. 5, a target is information that a user recognizes in advance before inputting a password and this information may be stored in the memory 110. A user may find a target that the user recognizes and a character of password that the user remembers and may match the two objects to coordinates of a skin image in the password input interface 200. By doing so, one character of the password is determined and inputted and this is possible because the user already knows the target information set by the control unit 100.

The inputting of characters of password may be performed the same times as length of character string of the password. The target may be set uniform with respect to all of inputted password characters for the user convenience and an independent target may be set to every character of the password in order to increase safety.

In order to position the target and the password character at the same coordinates of the skin image, a user may use a touch screen or arrow keys of a keypad, which may be included in the interface 106. The touch screen and the arrow keys of a keypad may determine up, down, right, and left directions (extended to eight directions) and may be used to move characters (or targets) in the determined direction.

For example, it is assumed that, on a password input interface arranged like a reference numeral 500, a user authentication includes a single target and a single password wherein the target is blue and a password character to be inputted is ‘2’, and wherein the target is moved by one block by an arrow key which has up, down, right, and left directional buttons.

A user may press a right button and move all target candidates right by one coordinate position (for example, target candidates positioned at the rightmost coordinate side by one may be positioned at the leftmost coordinate on the same row) to convert a screen into an interface 502, and may press an upper button and move all target candidates left by one coordinate position (for example, target candidates positioned at the uppermost coordinate on the screen may be positioned at the lowermost coordinate on the same column) to convert the screen into an interface 504 in which a blue target is matched to a password character ‘2’.

When target color and the password character are positioned at the same position, a user may input a character by touching a position at which a command can be input on the touch screen, through an ENTER key 210 as shown in FIG. 2, or a hardware input button.

The above-described example of inputting a character is made by assuming the buttons having up, down, right, and left directions and the touch input, that the characters are fixed, and that the target candidates are moved. Under this assumption, a user may press buttons three times at maximum to match the target to the password character on the given skin image.

If eight arrow keys are used, the target may be matched to the password character by maximum two pressing of the buttons. When the target candidates are expressed with only one image (however, each of the target candidates may include an image map or image coordinate information) and a touch screen is used, the target may be matched to the password character by only one movement of an image (for example, an image is dragged to a specific position while touching the touch screen).

By doing so, a shoulder-surfing attacker, who does not know a target, cannot detect which character the user inputs. Moreover, even a malicious logger program installed in the password input device cannot detect the inputted character from input log.

FIG. 6 is a flow chart illustrating registering of a user password in a user terminal in accordance with the embodiment of the present invention.

Referring to FIG. 6, a user determines whether to select and keep target information in mind in step of registering a password, or whether to receive the target information from the control unit 100 of a user terminal every authenticating step. The control unit 100 requests the user whether to register his/her password and the target information into the user terminal through the display unit 108 connected to the interface 106 (for example, a touch screen) and receives a command about the request in step S600.

When a user inputs a command of registering only password, step S606 is performed. When the user inputs a command of registering the target information with the password, step S602 is carried out such that the display unit 108 displays lists of all target candidates that are transmitted from the control unit 100 to the user. The control unit 100 transmits a target selected from the target candidates by the user from the interface 106 to the target manager 102. The target manager 102 registers the selected target as a target and transmits the target to the memory 110 to store.

A place in which the target is stored, that is, a storing region of the memory 110 is nothing to do with the shoulder-surfing attack. Additional security measure is required in order for a user terminal in which this authentication information is installed to be safe from internal attack and all existing security program modules may be applied.

When the target registration is completed, or when the command of registering only password is received in step S600, the password manager 104 of the control unit 100 controls the display unit 108 connected to the interface 106 to display an interface of requesting a user for inputting of the password in step S606. In this case, all characters to be inputted are displayed on the interface.

When the password is inputted by the user, the control unit 100, the password manager 104 sets the password and transmits the same to the memory 110 to be stored in a specific region of the memory 110. In this case, passwords as many as a preset number of the password manager 104 or the number of inputted passwords may be set and standard of numbers, characters, special characters, and combination thereof may be set in advance.

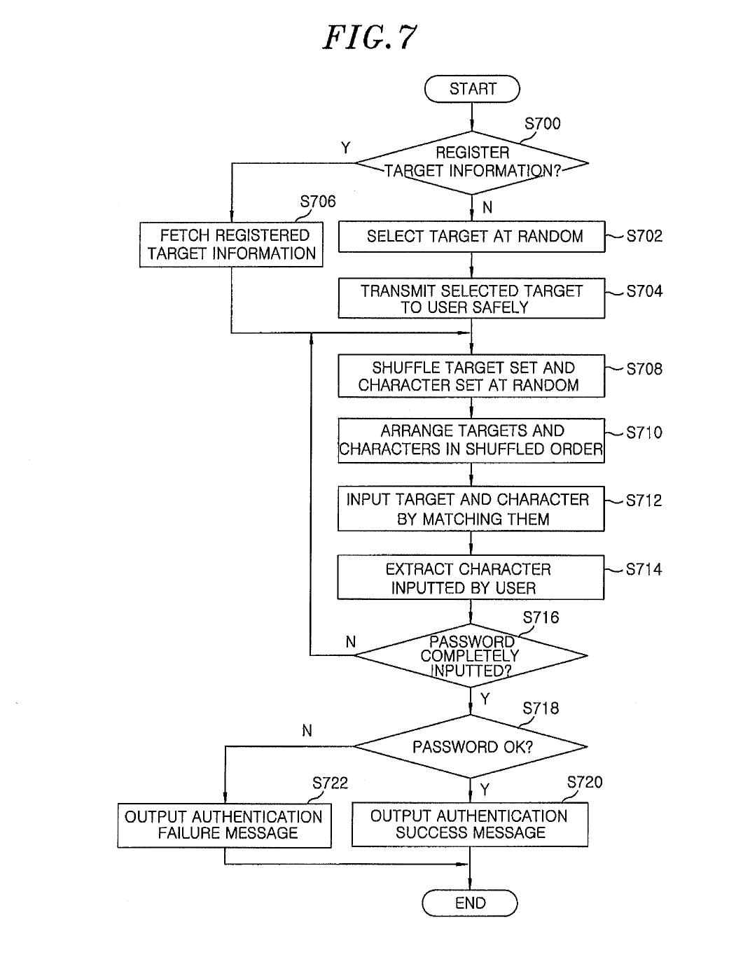

FIG. 7 is a flow chart illustrating process of inputting and authenticating a user password in a user terminal in accordance with the embodiment of the present invention.

Referring to FIG. 7, the control unit 100 controls the target manager 102 to determine whether a user selects and registers a target personally in the authentication step of the user terminal in step S700. When the target is already registered, the target manager 102 requests the memory 110 for information on the registered target and receives the information in step S706.

However, when the user does not register a target, the target manager 102 selects at least one target from the target candidate set at random in step S702. That is, when a four (4) digit password is set, all the digits of the password are assigned with same color or different colors.

The target manager 102 provides the set target to a user in step S704 such that an image CAPTCHA and an audio CAPTCHA are provided to the user for the purpose of safe transmission of the target.

In the situation where a user recognizes a target, the control unit 100 controls the target manager 102 and the password manager 104 to shuffle the target candidates and the character images at random in step S708 and to arrange the respective targets and characters on the skin image of the password input interface in step S710.

That is, unique numbers may be sequentially provided to each of the targets and characters in the shuffled order and the targets and characters are arranged on the respective skin images matched to the provided unique numbers.

A user, as illustrated in FIG. 5, inputs a password character (or target) to be inputted by matching the password character to a coordinate at which the target (or password character) is positioned and the interface 106 receives the password character (or target) in step S712.

The interface 106 transmits information on match-up between the inputted target and password character to the control unit 100 such that the control unit 100 extracts a set target and the password character in step S714. When the password has four (4) digit structure, the step S708 is carried out again and the password character and the set target are extracted.

When the above operation is repeated until the four-digit password is inputted and the inputted password character and the target are positioned at the same preset position in step S718, the authentication success message is displayed by the display unit 108 or outputted in voice by the speaker 112 in step S720. When the inputted password character and the target are not at the same preset position, the authentication failure message is displayed by the display unit 108 or outputted in voice by the speaker 112 in step S722.

As described above, in accordance with the apparatus and method for inputting the user password of the present invention, a user of a digital device used at a public place may input his/her password characters in safety and conveniently against shoulder-surfing attack and a malicious logger inside the device through an authenticating method of matching the password characters to his/her targets at coordinates. The apparatus and method for inputting the user password may be easily implemented in a personal mobile digital device with a small screen and inconvenience for inputting such as a mobile phone.

While the invention has been shown and described with respect to the embodiments, it will be understood by those skilled in the art that various changes and modifications may be made without departing from the scope of the invention as defined in the following claims.

What is claimed is:

1. An apparatus for inputting a user password, comprising:
an interface receiving a command;
a control unit setting a target based on the command from the interface, receiving and storing a password character, and determining that authentication is successes only when the set target and the password character are positioned at a same coordinate on a skin image; and
a display unit connected to the interface to display the skin image of the interface that is transmitted from the control unit.

2. The apparatus of claim 1, wherein the control unit comprises:
a target manager shuffles a target set to select at least one target when there is not a set target; and
a password manager setting the password character and determining whether the set password character is sequentially inputted when the authentication is carried out.

3. The apparatus of claim 2, wherein the target manager sets at least one password character to one target.

4. The apparatus of claim 2, wherein the control unit generates a visually or acoustically transformed pattern and controls information on the selected target to be outputted on a screen or in sound when a value matched to the generated pattern is transmitted from the interface.

5. The apparatus of claim 2, further comprising:
a memory storing target setting information and password setting information which are transmitted from the target manager and the password manager respectively; and
a speaker outputting voice or sound corresponding to an authentication success message or an authentication failure message from the control unit.

6. The apparatus of claim 1, wherein the control unit provides random numbers to all targets and password characters such that the targets and the password characters are mapped to the numbers of the skin image one by one, and arranges the all of the targets and the password characters at coordinate positions to which unique numbers of the skin image are mapped based on the random numbers.

7. The apparatus of claim 6, wherein the skin image comprises position coordinates at which the password characters and the targets are displayed and the unique numbers of the position coordinates.

8. The apparatus of claim 1, wherein the control unit, when the authentication is performed, moves the password characters in preset directions based on the command transmitted from the interface while targets that are arranged at random are fixed, and extracts information on a password character positioned at the same coordinate as that at which a preset target is positioned when an input command is received from the interface.

9. The apparatus of claim 1, wherein the control unit, when the authentication is performed, moves the password characters in preset directions based on the command transmitted from the interface while targets that are arranged at random are fixed, and extracts information on a target positioned at the same coordinate as that at which a preset password character is positioned when an input command is received.

10. The apparatus of claim 1, wherein the target comprises one of color, a pattern, an icon, and a part of an image and the number thereof is equal to the number of characters displayed on the skin image.

11. The apparatus of claim 1, wherein each of the password characters comprises at least one of a number, a character, and a special character.

12. A method of inputting a user password, comprising:
receiving a command from an interface;
registering a target and a password character based on the command by a control unit;
displaying a skin image of the interface on which a plurality of targets and a plurality of password characters are arranged at random when authentication is performed; and
checking, when a command of requesting for authentication is received from the interface, extracted information and determining successful authentication only when the registered target and the registered password character are positioned at the same coordinate as that of the skin image.

13. The method of claim 12, wherein the registering comprises:
shuffling a target set at random and selecting at least one target when the password character only is registered based on the command; and
registering the selected target with at least one password character.

14. The method of claim 13, wherein the selecting of the target comprises:
generating a visually and acoustically transformed pattern by the control unit; and
controlling information on the selected target to be outputted on a screen or in sound when a value matched to the generated patter is transmitted from the interface.

15. The method of claim 12, wherein, in the determination, whether at least one registered password character is sequentially inputted from the interface is determined.

16. The method of claim 12, further comprising:
storing target setting information and password setting information which are transmitted from the control unit into a memory; and
outputting sound or voice corresponding to an authentication success message or an authentication failure message from the control unit to a speaker.

17. The method of claim 12, wherein the determination comprises:
moving the password characters in preset directions based on the command transmitted from the interface while targets that are arranged at random are fixed when the authentication is performed; and
extracting information on a password character positioned at the same coordinate as that at which a preset target is positioned when an input command is received from the interface.

18. The method of claim 12, wherein the determination comprises:
moving the password characters in preset directions based on the command transmitted from the interface while targets that are arranged at random are fixed when the authentication is performed; and
extracting information on a target positioned at the same coordinate as that at which a preset password character is positioned when an input command is received.

19. The method of claim 12, wherein the displaying comprises:
providing random numbers to all targets and password characters such that the targets and the password characters are mapped to the numbers of the skin image one by one; and
arranging the all of the targets and the password characters at coordinate positions to which unique numbers of the skin image are mapped based on the random numbers.

20. The method of claim 12, wherein the target comprises one of color, a pattern, an icon, and a part of an image and the number thereof is equal to the number of characters displayed on the skin image.
